(19) United States
(12) Patent Application Publication
(10) Pub. No.: US 2025/0383022 A1
(43) Pub. Date: Dec. 18, 2025

(54) COOLANT CONTROL VALVE

(71) Applicant: Schaeffler Technologies AG & Co. KG, Herzogenaurach (DE)

(72) Inventor: Thomas Gillespie, Royal Oak, MI (US)

(73) Assignee: Schaeffler Technologies AG & Co. KG, Herzogenaurach (DE)

(21) Appl. No.: 19/238,552

(22) Filed: Jun. 16, 2025

Related U.S. Application Data
(60) Provisional application No. 63/661,525, filed on Jun. 18, 2024.

(51) Int. Cl. F16K 5/06; F16K 31/04

(52) U.S. Cl. CPC F16K 5/0621; F16K 31/042

(57) ABSTRACT

A coolant control valve includes an electric actuator and a valve housing having a first housing and a second housing. The first housing includes a first fluid chamber, at least one inlet, and at least one outlet. The second housing includes a second fluid chamber, at least one inlet and at least one outlet. A rotary ball valve is disposed within the first fluid chamber and actuated about a first axis by the electric actuator. A rotary disc valve, having at least one fluid opening, is disposed within the second fluid chamber and non-rotatably coupled to the rotary ball valve.

### CROSS-REFERENCE TO RELATED APPLICATIONS

This application claims priority to U.S. Provisional Application 63/661,525 filed Jun. 18, 2024, the entire disclosure of which is incorporated by reference herein.

### TECHNICAL FIELD

This disclosure is generally related to a coolant control valve (CCV).

### BACKGROUND

CCVs are known and can be arranged to provide coolant flow control for temperature management of various powertrain components of vehicles, including but not limited to battery electric vehicles (BEV), hybrid electric vehicles (HEV), fuel cell vehicles (FCV), and internal combustion engine vehicles (ICEV).

A portion of CCVs are electro-mechanical in design, incorporating an electrical actuator that interfaces with a mechanical valve body to provide a controlled flow of coolant for a selected powertrain/propulsion component or system. Depending on its design, the mechanical valve body can be linearly actuated or rotary actuated by an actuator, often times in the form of an electric motor or solenoid. The valve body can have one or more fluid openings that control an amount of coolant flow to or from one or more inlets or outlets arranged on a housing of the coolant control valve. Example embodiments of electro-mechanical CCVs include: i) an on/off type that provides either a fixed coolant flow state or a no-flow state, or ii) a fully variable type that provides continuously variable positions of the valve body to achieve various coolant flow rates.

### SUMMARY

An example embodiment of a coolant control valve (CCV) includes an electric actuator, a valve housing, a rotary ball valve and a rotary disc valve. The valve housing includes a first housing and a second housing. Each of the first housing and the second housing have at least one inlet and at least one outlet. The rotary ball valve is disposed within a first fluid chamber of the first housing and the rotary disc valve is disposed within a second fluid chamber of the second housing. The first fluid chamber and the second fluid chamber are axially adjacent to each other. The rotary disc valve is non-rotatably coupled to the rotary ball valve. The rotary ball valve and the rotary disc valve are actuated in unison about a first axis by the electric actuator. Each of the rotary disc valve and the rotary ball valve have at least one fluid opening.

In an example embodiment, the first housing is arranged between the electric actuator and the second housing in an axial direction.

In an example embodiment, a wall of one of the first housing or the second housing separates the first fluid chamber from the second fluid chamber.

In an example embodiment, the rotary disc valve is disposed in the first fluid chamber and the second fluid chamber.

In an example embodiment, the at least one inlet of the first housing includes a first inlet extending through the second housing. In a further aspect, the first housing includes a first outlet and the first inlet is disposed radially inwardly of the first outlet.

In an example embodiment, the at least one outlet of the first housing includes a first outlet extending through the second housing. In a further aspect, the first outlet is scalingly isolated from the second fluid chamber.

An example embodiment of a CCV includes an electric actuator that actuates a rotary valve about a first axis. The rotary valve includes a first rotary valve and a second rotary valve non-rotatably coupled to the first rotary valve. The first rotary valve has a hollow body that defines an internal fluid chamber. The internal fluid chamber receives fluid in a first axial direction and exits fluid in a radial direction. The second rotary valve has a disc portion that receives fluid in the first axial direction and exits fluid in a second axial direction opposite to the first axial direction. The electric actuator, the first rotary valve, and the second rotary valve are stacked axially along the first axis.

In an example embodiment, the first rotary valve is disposed within a first fluid chamber, and the second rotary valve is disposed within a second fluid chamber separate from the first fluid chamber. In a further aspect, the CCV includes a first housing that defines the first fluid chamber and a second housing that defines a second fluid chamber. The disc portion can include at least one fluid opening that extends through the disc portion, and the at least one fluid opening is in selective fluid communication with at least one outlet of the second housing.

In an example embodiment, the second housing includes a first inlet fluid opening receives fluid into the second fluid chamber.

In an example embodiment, the disc portion includes a first fluid opening that receives fluid from the first inlet opening and a second fluid opening that exits fluid from the second fluid chamber. In a further aspect, the second housing can have at least two outlets, and the second fluid opening rotates so as to selectively vary an overlap between the second fluid opening and two of the at least two outlets. In yet a further aspect, the second housing can have three outlets, and the second outlet fluid opening fluidly connects at least two different pairs of the three outlets to the first inlet fluid opening.

An example embodiment of a CCV includes an electric actuator and a housing. The housing includes at least one inlet, at least one outlet, a first fluid chamber, and a second fluid chamber that is axially adjacent to the first fluid chamber. A rotary hollow body valve is disposed in the first fluid chamber. A rotary disc valve is non-rotatably coupled to the rotary ball valve. The rotary disc valve includes a disc portion that is disposed in the second fluid chamber so as to divide the second fluid chamber into a third fluid chamber and a fourth fluid chamber, the fourth fluid chamber axially adjacent to the third fluid chamber. The disc portion includes a first fluid opening that receives fluid from one of the at least one inlet or one of the at least one outlet arranged in the third fluid chamber and delivers the fluid to the fourth fluid chamber. The disc portion further includes a second fluid opening that receives fluid from the fourth fluid chamber via the first fluid opening and delivers the fluid to: i) a first one and a second one of the at least one outlet arranged in the third fluid chamber, or ii) a first one and a second one of the at least one inlet arranged in the third fluid chamber.

In an example embodiment, the fourth fluid chamber is arranged between the first fluid chamber and the third fluid chamber in an axial direction.

In an example embodiment, the second fluid opening selectively throttles a fluid flow, via the electric actuator, to: i) the first one of the at least one outlet and to the second one of the at least one outlet, or ii) the first one of the at least one inlet and to the second one of the at least one inlet.

In an example embodiment, in a first rotational position of the rotary disc valve, the second fluid opening delivers fluid only to: i) the first one of the at least one outlet, or ii) the first one of the at least one inlet.

In an example embodiment, in a second rotational position of the rotary disc valve, the second fluid opening delivers fluid only to: i) the second one of the at least one outlet, or ii) the second one of the at least one inlet.

In an example embodiment, in a third rotational position of the rotary disc valve, the second fluid opening delivers throttled fluid to: i) the first one and the second one of the at least one outlet, or ii) the first one and the second one of the at least one inlet.

In an example embodiment, one of the at least one inlet or one of the at least one outlet extends axially through the second fluid chamber and a remaining one of the one of the at least one outlet or the one of the at least one outlet extends axially through the second fluid chamber.

In an example embodiment, a tubular portion of the rotary disc valve is configured as one of the at least one inlet or one of the at least one outlet.

### BRIEF DESCRIPTION OF THE DRAWINGS

FIG. 1 shows a perspective view of an example embodiment of a coolant control valve (CCV) and a fluid manifold.

FIGS. 2A and 2B show perspective views of an example embodiment of a cap for the CCV of FIG. 1.

FIG. 3 shows an exploded perspective view of the CCV and fluid manifold of FIG. 1.

FIGS. 4A and 4B show perspective views of an example embodiment of a rotary ball valve for the CCV of FIG. 1.

FIGS. 5A and 5B show perspective views of an example embodiment of a first housing for the CCV of FIG. 1.

FIGS. 6A and 6B show perspective views of an example embodiment of a port insert for the CCV of FIG. 1.

FIG. 7 shows a perspective view of an example embodiment of a rotary disc valve for the CCV of FIG. 1.

FIG. 8 shows a perspective view of an example embodiment of a second housing for the CCV of FIG. 1.

FIG. 9 shows a perspective view of the fluid manifold of FIG. 1.

FIG. 10 shows a perspective view of a subassembly of the rotary disc valve, the second housing, and the fluid manifold.

FIG. 11A shows a cross-sectional view taken from FIG. 1 with the CCV in a first rotational position of a first cooling mode.

FIG. 11B shows a cross-sectional view taken from FIG. 1 with the CCV in the first rotational position of the first cooling mode.

FIG. 11C shows a top view of the subassembly of FIG. 10 with the CCV in the first rotational position of the first cooling mode.

FIG. 12A shows a cross-sectional view taken from FIG. 1 with the CCV in a second rotational position of the first cooling mode.

FIG. 12B shows a top view of the subassembly of FIG. 10 with the CCV in the second rotational position of the first cooling mode.

FIG. 13A shows a cross-sectional view taken from FIG. 1 with the CCV in a third rotational position of the first cooling mode.

FIG. 13B shows a top view of the subassembly of FIG. 10 with the CCV in the third rotational position of the first cooling mode.

FIG. 14A shows a cross-sectional view taken from FIG. 1 with the CCV in a first rotational position of a second cooling mode.

FIG. 14B shows a cross-sectional view taken from FIG. 1 with the CCV in the first rotational position of the second cooling mode.

FIG. 14C shows a top view of the subassembly of FIG. 10 with the CCV in the first rotational position of the second cooling mode.

FIG. 15A shows a cross-sectional view taken from FIG. 1 with the CCV in a second rotational position of the second cooling mode.

FIG. 15B shows a top view of the subassembly of FIG. 10 with the CCV in the second rotational position of the second cooling mode.

FIG. 16A shows a cross-sectional view taken from FIG. 1 with the CCV in a third rotational position of the second cooling mode.

FIG. 16B shows a top view of the subassembly of FIG. 10 with the CCV in the third rotational position of the second cooling mode.

FIG. 17A shows a schematic representation of the first cooling mode and the first, second, and third rotational positions thereof.

FIG. 17B shows a schematic representation of the second cooling mode and the first, second, and third rotational positions thereof.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

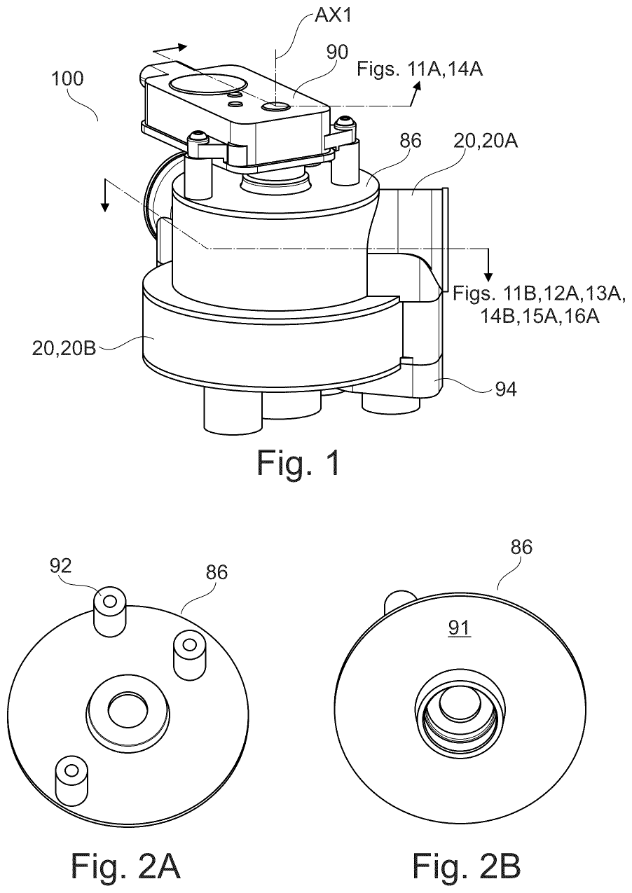

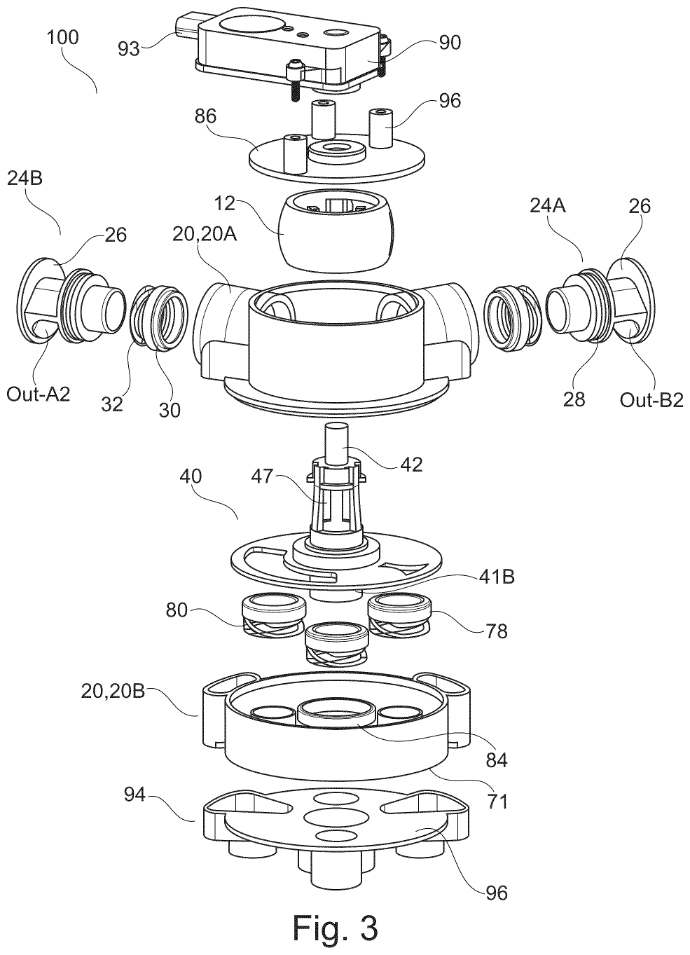

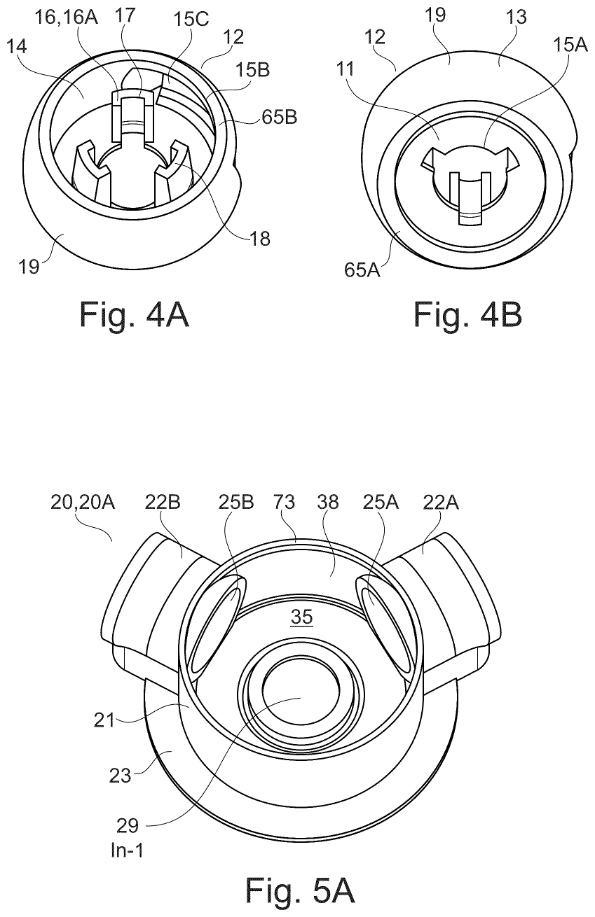

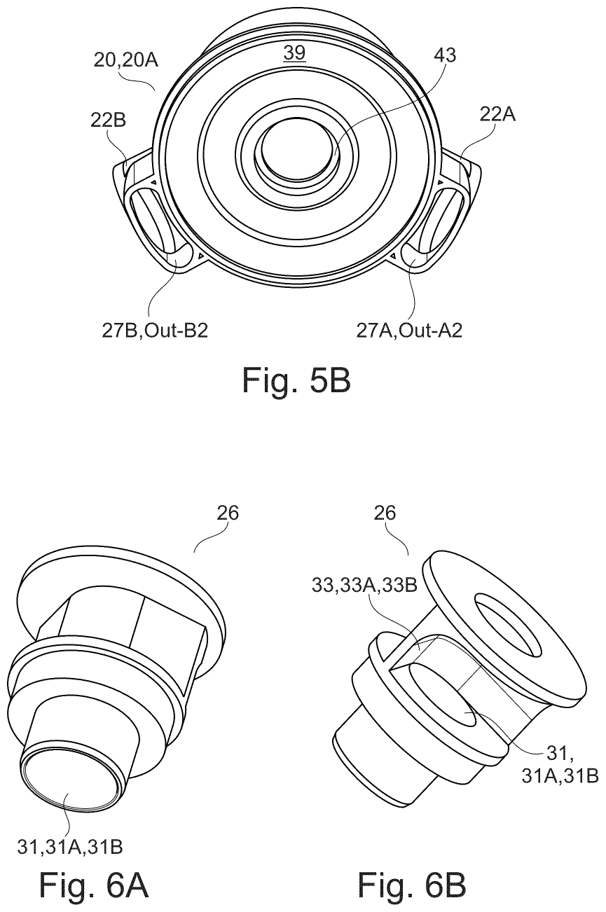

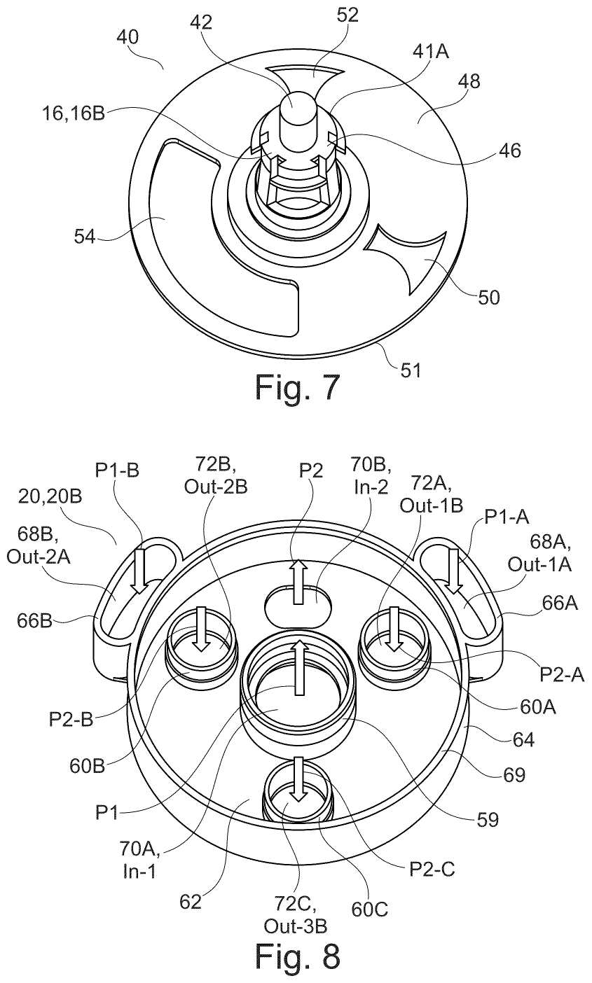

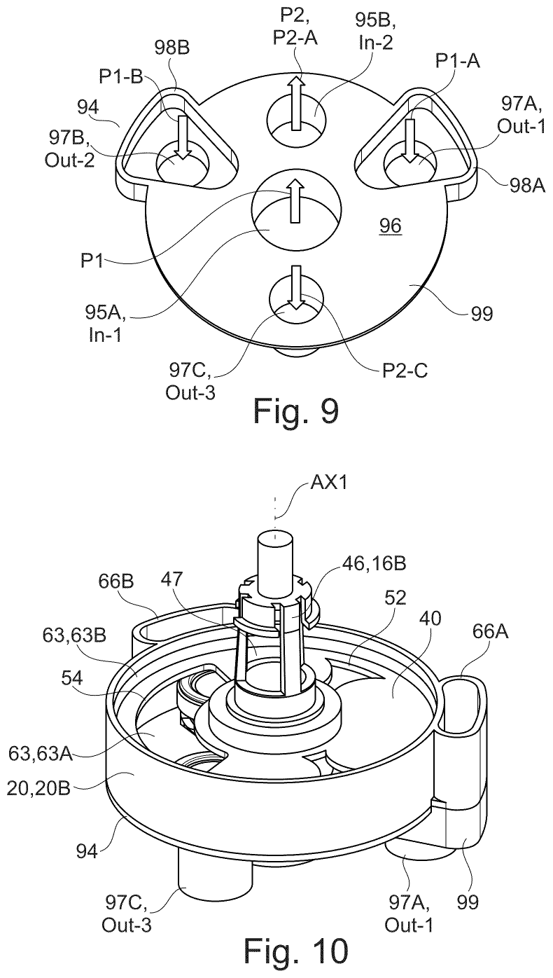

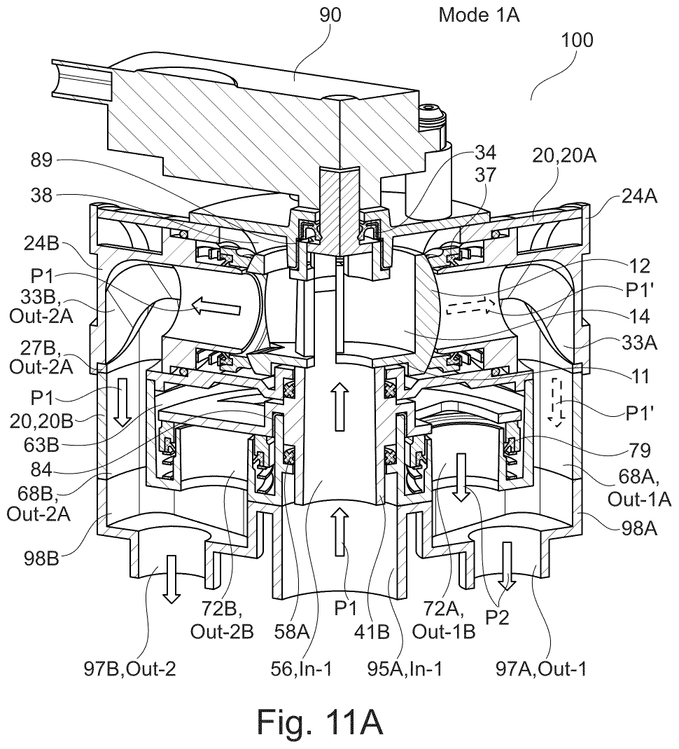

FIG. 1 shows a perspective of a coolant control valve (CCV) 100 together with an optional fluid manifold 94. FIGS. 2A and 2B show perspective views of an example embodiment of a cap 86 for the CCV 100. FIG. 3 shows an exploded perspective view of the CCV 100 and the optional fluid manifold 94. FIGS. 4A and 4B show perspective views of an example embodiment of a rotary ball valve (RBV) 12 for the CCV 100. FIGS. 5A and 5B show perspective views of an example embodiment of a first housing 20A for the CCV 100. FIGS. 6A and 6B show perspective views of an example embodiment of a port insert 26 for the CCV 100. FIG. 7 shows a perspective view of an example embodiment of a rotary disc valve (RDV) 40 for the CCV 100. FIG. 8 shows a perspective view of an example embodiment of a second housing 20B for the CCV 100. FIG. 9 shows a perspective view of the optional fluid manifold 94. FIG. 10 shows a perspective view of a subassembly of the RDV 40, the second housing 20B, and the optional fluid manifold 94. The following should be read in light of FIGS. 1 through 10.

The CCV 100 includes an electric actuator 90, a housing 20, and the cap 86. The electric actuator 90 is fixed to the CCV 100 via axially extending bosses 92 arranged or formed on the cap 86. The electric actuator 90 could include an electric motor or any other suitable actuator type together with a transmission. The housing 20 can be described as a two-piece housing that includes the first housing 20A and the second housing 20B. A bottom surface 91 of the cap 86 sealingly engages a top surface 73 of the housing 20. The RBV 12 resides or is housed within the first housing 20A, and the RDV 40 resides or his housed within the second housing 20B. The electric actuator 90 is controlled via an electronic controller (not shown) that electronically communicates with the electric actuator 90 via an electrical connector 93 as is known in the field of coolant control valves. In an example embodiment, the electric actuator 90 actuates or rotates the RBV 12 and the RDV 40 in both clockwise and counterclockwise directions about a rotational axis AX1 to any desired rotational position within a continuous range of rotational positions. Alternatively stated, the CCV 100 and the rotational positions thereof, are continuously variable, such that the RBV 12 and the RDV 40 can be rotated to and stopped at any desired rotational angle within a continuous range of rotational angles.

The electric actuator 90, first housing 20A, and second housing 20B are stacked axially such that the first housing 20A resides between the electric actuator 90 and the second housing 20B along the rotational axis AX1. The RBV 12 is non-rotatably connected to the RDV 40; that is, the RBV 12 is torsionally coupled to the RDV 40 such that relative rotation between the RBV 12 and the RDV 40 does not occur. In this context, the RBV 12 and RDV 40 define a coupling 16. The RBV 12 includes axially extending fingers 18 that define a first coupling portion 16A, and the RDV 40 includes axially extending columns 46 that define a second coupling portion 16B. The fingers 18 of the RBV 12 define grooves 17 which slidably receive the columns 46 to form the coupling 16 and the non-rotatable connection.

The RBV 12 is formed as a spherical segment 19 or a sphere with truncated ends. The RBV 12 could also be described as a hollow body rotary valve. A first end 65A of the spherical segment 19 includes a base or bottom wall 11 from which a curved wall 13 extends. A first fluid opening 15A is formed in the bottom wall 11. A second end 65B of the spherical segment 19 (or top of the curved wall 13) is open defining a second fluid opening 15B. The curved wall 13 of the spherical segment 19 defines a third fluid opening 15C from which fluid can exit the RBV 12 in a radial direction that is orthogonal to the rotational axis AX1. The first fluid opening 15A facilitates an incoming flow of fluid in an axial direction into an internal fluid chamber 14 formed by the curved wall 13. Fluid within the internal fluid chamber 14 can exit the RBV 12 in an axial direction via the second fluid opening 15B or in the radial direction via the third fluid opening 15C.

The RDV 40 includes a disc portion 48, a first axial extension 41A that extends above the disc portion 48, and a second axial extension 41B that extends below the disc portion 48. A post 42, extending from a top of the first axial extension 41A, is engaged with and rotatably driven by the electric actuator 90. The first axial extension 41A includes the previously described columns 46 that define the second coupling 16B. The second axial extension 41B could be described as tubular-shaped. The disc portion 48 includes a first fluid opening 50, a second fluid opening 52, and a third fluid opening 54. The first, second, and third fluid openings 50, 52, 54 are separated and distinct from each other and can be of any suitable shape that accommodates fluid flow, as will be described later.

The RBV 12 resides in the first housing 20A. The first housing 20A is cup-shaped and has a base wall 23 from which a cylindrical wall 21 extends. The base wall 23 (particularly, a first side 35 thereof), the cylindrical wall 21, and the bottom surface 91 of the cap 86 define a first fluid chamber 38 within which the RBV 12 is disposed. The base wall 23 includes an offset bore 43 and a through-aperture 29 extending therethrough that receives the first axial extension 41A of the RDV 40. The through-aperture 29 defines a portion of a first inlet In-1 of the CCV 100 that serves as an inlet to the first housing 20A. The cylindrical wall 21 includes a first outlet port 22A and a second outlet port 22B that are tubular in shape. The first outlet port 22A and the second outlet port 22B include respective first port openings 25A, 25B and respective second port openings 27A, 27B. The first port opening 25A of the first outlet port 22A receives a first insert assembly 24A and the second port opening 25B of the second outlet port 22B receives a second insert assembly 24B which can be identical to the first insert assembly 24A. The first and second insert assemblies 24A, 24B can also be different. The first and second insert assemblies 24A, 24B include a port insert 26 and an O-ring 28 that seals the port insert 26 to the respective first and second port openings 25A, 25B. The port insert 26 includes a first fluid gallery 31 (radially extending) and a second fluid gallery 33 (axially extending) adjoined to the first fluid gallery 31 that, together define a fluid passage shaped as a 90-degree elbow that extends from the first fluid chamber 38.

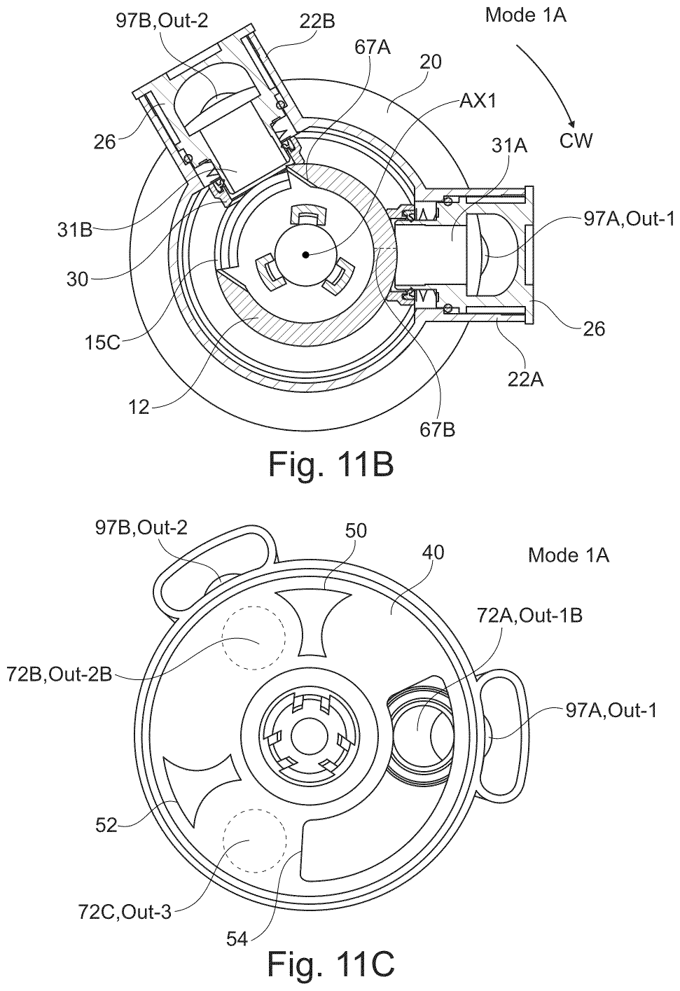

The curved wall 13 of the RBV 12 is sealed to the first and second insert assemblies 24A, 24B via sealing rings 30 and bias force generators 32 that are arranged at each end of the first and second insert assemblies 24A, 24B. The sealing rings 30 can move radially relative to the rotational axis AX1 via the bias force generators 32 to compensate for tolerances and form of the RBV 12 and interfacing components. The bias force generators 32 push the sealing rings 30 against the curved wall 13 during rotation of the RBV 12. In an example embodiment, the bias force generators 32 are wave springs but can be any suitable spring or elastomer that is capable of providing a bias force. Further, lip seals 37 (FIG. 11A) are disposed radially between the sealing rings 30 and an outer surface of the port inserts 26 to provide dynamic sealing of this interface during radial movement of the sealing rings 30.

The RDV 40 resides in the second housing 20B. The second housing 20B is cup-shaped and includes a bottom wall 62 from which a cylindrical wall 64 extends. A top surface 69 of the second housing 20B sealingly engages a second side 39 of the base wall 23 of the first housing 20A. The bottom wall 62, the cylindrical wall 64 and the base wall 23 (particularly, the second side 39 thereof) define a second fluid chamber 63 within which the RDV 40 is disposed. Separate from the second fluid chamber 63 are first and second cars 66A, 66B that extend radially outwardly from the cylindrical wall 64. The first and second cars 66A, 66B define respective first and second fluid galleries 68A, 68B that extend through the second housing 20B that are separated or isolated from the second fluid chamber 63 via the cylindrical wall 64. The first and second fluid galleries 68A, 68B define respective first and second outlets Out-1A, Out-2A. The bottom wall 62 includes a first inlet opening 70A, a second inlet opening 70B, a first outlet opening 72A, a second outlet opening 72B, and a third outlet opening 72C. The first, second, and third outlet openings 72A, 72B, 72C define respective first, second, and third outlets Out-1B, Out-2B, Out-3B. The first, second, and third outlet openings 72A, 72B, 72C are all springably sealed against a bottom surface 51 of the RDV 40 via sealing rings 78 and bias force generators 80. The scaling rings 78 can move axially relative to the rotational axis AX1 via the bias force generators 80 to compensate for tolerances and form of the RDV 40. The bias force generators 80 push the scaling rings 78 against the bottom surface 51 during rotation of the RDV 40. Further, lip seals 79 (FIG. 11A) provide sealing between the sealing rings 78 and axial extensions 60A, 60B, 60C of the respective first, second, and third outlet openings 72A, 72B, 72C to provide dynamic sealing of this interface during axial movement of the sealing rings 78. In an example embodiment, the bias force generators 80 are wave springs or any suitable spring or elastomer that can provide a bias force. The sealing rings 78 can be constructed of plastic, coated plastic, or any suitable material.

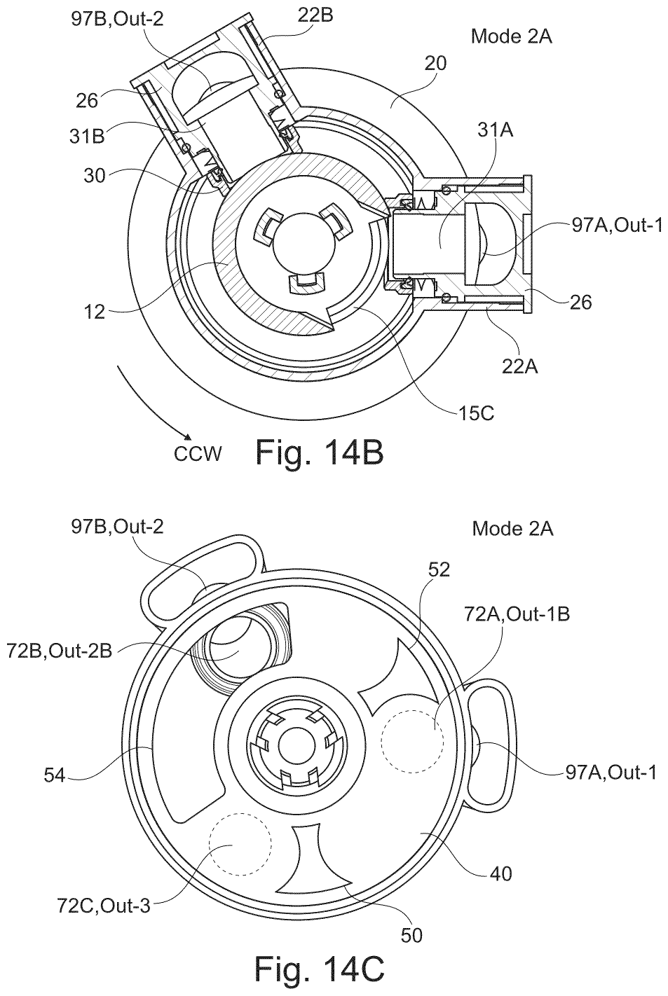

Turning to FIGS. 11A and 14A, radial seals 58A, 58B are respectively arranged between: i) the bore 43 of the first housing 20A and the first axial extension 41A of the RDV 40, and ii) the axial extension 59 of the first inlet opening 70A of the second housing 20B and the second axial extension 41B of the RDV 40. A lip seal 34 is arranged between the cap 86 and the post 42 of the RDV 40 to prevent fluid leakage from the top of the CCV 100. A first bushing 84 is arranged between the RDV 40 and the second housing 20B and a second bushing 89 is arranged between the cap 86 and the RDV 40. The first and second bushings 84, 89 are configured as a combined axial and thrust bearing and can be L-shaped or any other suitable shape.

The first fluid chamber 38 of the first housing 20A is sealingly isolated from the second fluid chamber 63 of the second housing 20B. Further, the disc portion 48 of the RDV 40 separates the second fluid chamber 63 into a third fluid chamber 63A and a fourth fluid chamber 63B.

The fluid manifold 94 is an optional component that can sealingly engage with the CCV 100. In an example embodiment, the fluid manifold 94 is a component of the CCV 100. In an example embodiment, the fluid manifold 94 is a component of a vehicle, and the CCV 100 mounts onto the fluid manifold 94 which is installed in the vehicle before the CCV 100. In a further aspect, the fluid manifold 94 is a component of a chassis of the vehicle. In yet a further aspect, the fluid manifold 94 is a component of a thermal management system arranged within the vehicle.

Turning to FIG. 9, the fluid manifold 94 includes a disc portion 99, a first cupped outcropping 98A that includes a first outlet opening 97A, a second cupped outcropping 98B that includes a second outlet opening 97B, a third outlet opening 97C, a first inlet opening 95A, and a second inlet opening 95B. The first outlet opening 97A defines a first outlet Out-1, the second outlet opening 97B defines a second outlet Out-2, and the third outlet opening 97C defines a third outlet Out-3. The first inlet opening 95A defines a portion of the first inlet In-1 of the CCV 100, and the second inlet opening 95B defines a portion of a second inlet In-2 of the CCV 100. A top surface 96 of the fluid manifold 94 is sealingly engaged with a bottom surface 71 of the second housing 20B.

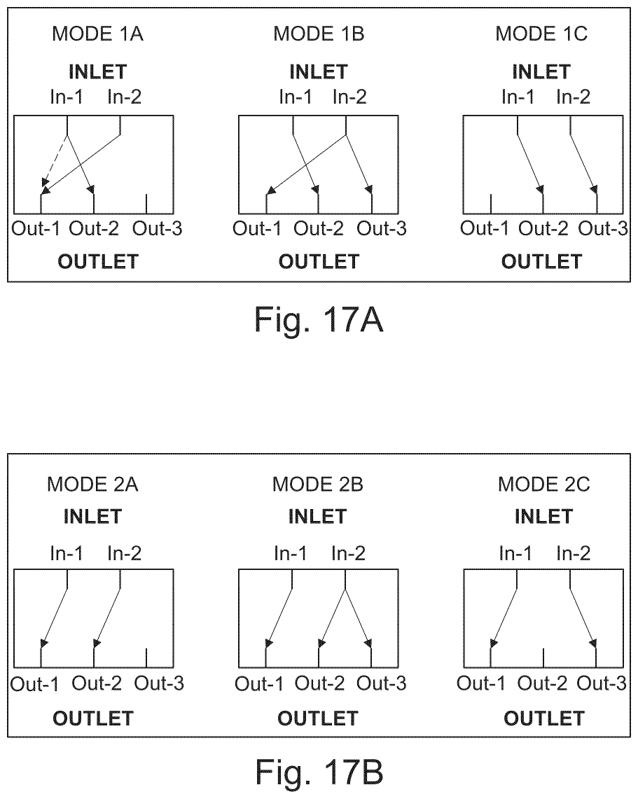

Turning to FIGS. 11A through 16B, six different rotational positions of the RBV 12 and RDV 40 are shown that encompass two different cooling modes (mode 1, mode 2), as schematically depicted in FIGS. 17A and 17B. FIGS. 11A through 13B depict three different rotational positions of a first cooling mode (mode 1), and FIGS. 14A through 16B depict three different rotational positions of a second cooling mode (mode 2).

Turning to FIGS. 11A through 11C, a first rotational position of the first cooling mode (mode 1), identified as mode 1A, is shown. In this mode, two sealingly isolated first and second fluid flow pathways P1, P2 are present within the CCV 100. Each of the first and second fluid flow pathways P1, P2 have separate respective first and second inlets In-1, In-2. The routing of the first and second fluid flow pathways P1, P2 will now be described.

For the first fluid flow pathway P1, fluid enters the first inlet In-1 via the first inlet opening 95A of the fluid manifold 94, the first inlet opening 70A of the second housing 20B, and a ball valve inlet opening 56 of the second axial extension 41B of the RDV 40. Fluid flows upward to the RBV 12 (via the through-aperture 29 of the first housing 20A) and through the first fluid opening 15A to a fluid space 47 defined by the columns 46 of the RDV 40, and radially outwardly therefrom to the internal fluid chamber 14 defined by the curved wall 13 of the RBV 12. As shown in FIGS. 11A and 11B, the third fluid opening 15C of the RBV 12 overlaps with the first fluid gallery 31B of the second outlet port 22B of the first housing 20A, therefore fluid flows from the internal fluid chamber 14 to the first fluid gallery 31B. From the first fluid gallery 31A, fluid flows through: a second fluid gallery 33B (of the second insert assembly 24B), the second port opening 27B, the second fluid gallery 68B, the second cupped outcropping 98B, and the second outlet opening 97B of the fluid manifold 94. Since no portion of the third fluid opening 15C overlaps with the first fluid gallery 31A of the first outlet port 22A, fluid flow is blocked from entering the first outlet port 22A.

As shown in FIG. 11A, a portion of the first inlet In-1, via the second axial extension 41B of the RDV 40, extends through the second housing 20B and fluidly connects to the first housing 20A. It could also be stated that the first inlet In-1, via the second axial extension 41B of the RDV 40, is scalingly isolated from other fluid flows or pathways (inlet or outlet) that pass through the second housing 20B.

For the second fluid flow pathway P2, fluid enters the second inlet In-2 of the CCV 100 via the second manifold inlet opening 95B and the second inlet opening 70B of the second housing 20B. Fluid flows upward to the third fluid chamber 63A and then to the fourth fluid chamber 63B via the first fluid opening 50 of the RDV 40. From the fourth fluid chamber 63B, fluid flows back down to the third fluid chamber 63A via the third fluid opening 54 of the RDV 40. As shown in FIG. 11C, fluid then flows out of the first outlet opening 72A of the second housing 20B since the third fluid opening 54 overlaps with the first outlet opening 72A. From the first outlet opening 72A, fluid then flows out of the first cupped outcropping 98A and the first outlet opening 97A of the fluid manifold 94.

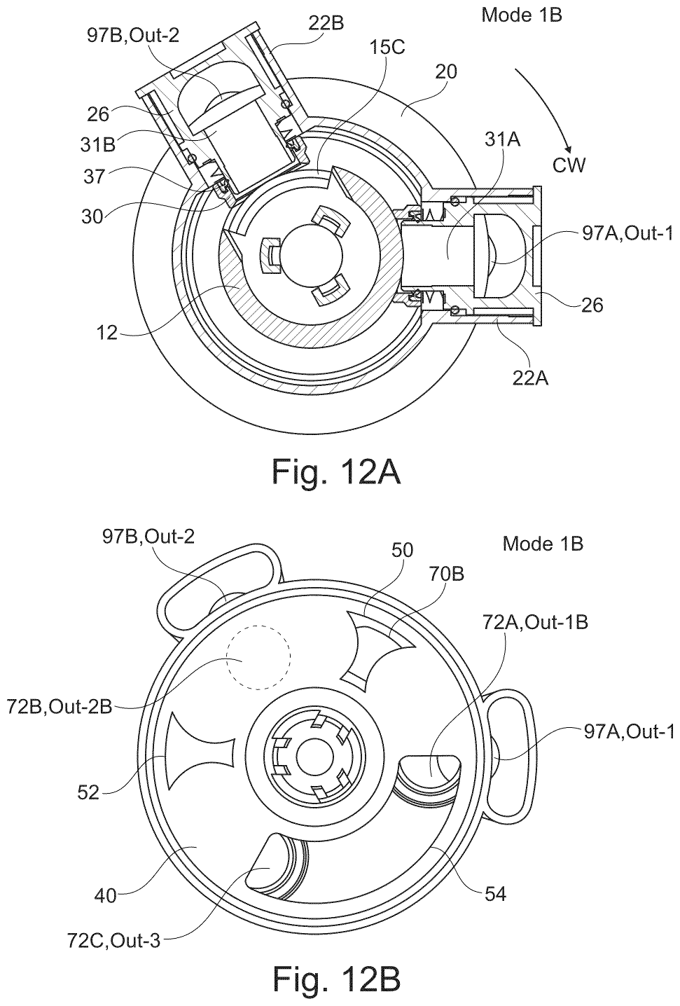

Turning to FIGS. 12A, 12B, a second rotational position of the first cooling mode, identified as mode 1B, is shown. In this mode, incoming fluid enters the first inlet In-1 and the second inlet In-2 of the CCV 100 as described earlier for mode 1A. However, in this rotational position, the RBV 12 and the RDV 40 are rotated in a clockwise direction CW relative to the first rotational position of mode 1A. In this position, the fluid flow pathway through the CCV 100 after the fluid enters the first inlet In-1 is the same as described earlier for mode 1A. However, in mode 1B, the fluid flow pathway through the CCV 100 after the fluid enters the second inlet In-2 is slightly different. As shown in FIG. 12B, fluid flows out of both the first outlet opening 72A and the third outlet opening 72C of the second housing 20B since the third fluid opening 54 overlaps both first outlet opening 72A and the third outlet opening 72C. From the first outlet opening 72A, fluid then flows out of the first cupped outcropping 98A and the first outlet opening 97A of the fluid manifold 94. From the third outlet opening 72C, fluid then flows out of the third outlet opening 97C of the fluid manifold 94. It should be noted from FIG. 12B that a slightly further clockwise CW rotation of the RBV 12 and the RDV would yield a lower overlap between the third fluid opening 54 and the first outlet opening 72A, yielding a lower fluid flow rate, and a greater overlap between the third fluid opening 54 and the third outlet opening 72C, yielding a greater fluid flow rate. Furthermore, the overlap can vary for each of the first and third outlet openings 97A, 97C from zero or no overlap (no flow) to full overlap (maximum flow).

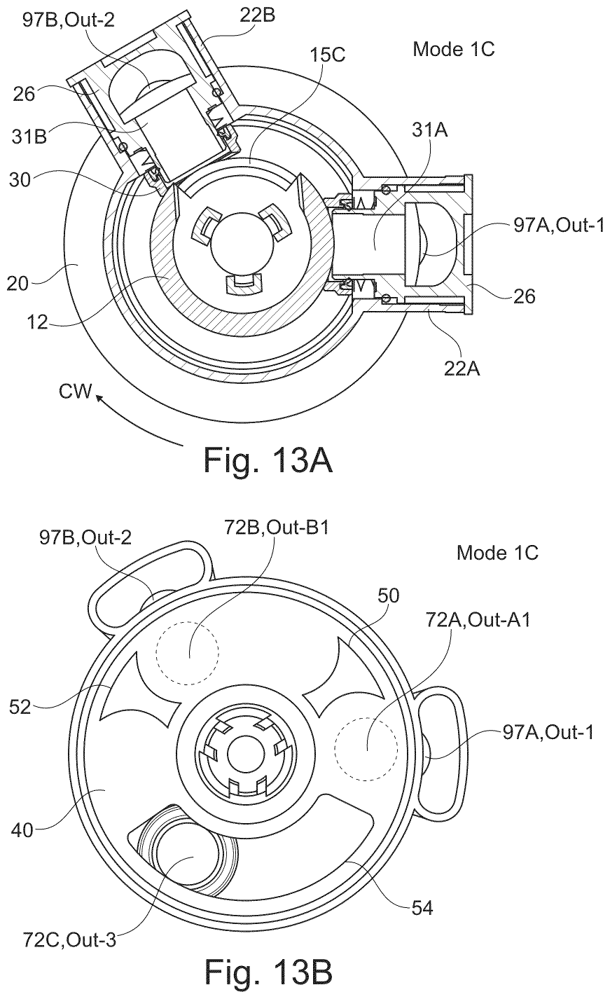

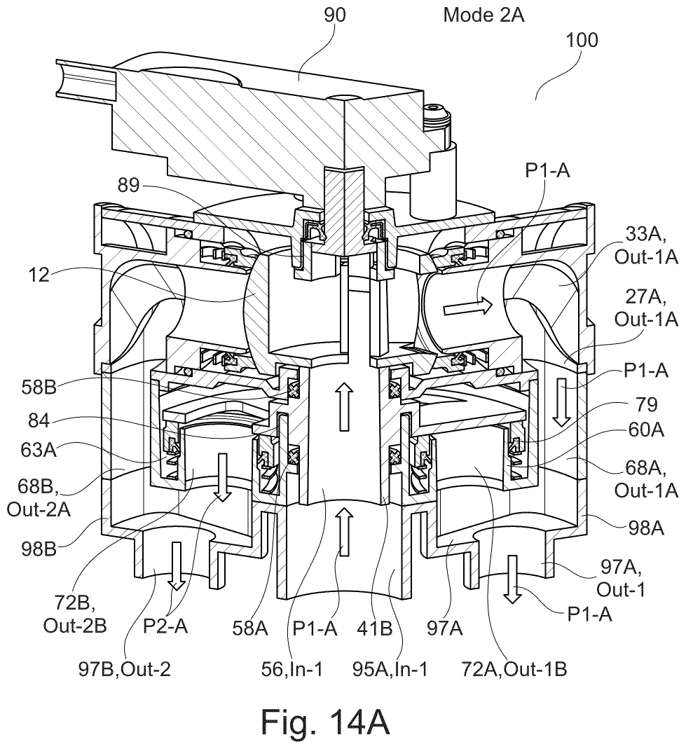

Turning to FIGS. 13A, 13B, a third rotational position of the first cooling mode, identified as mode 1C, is shown. In this mode, incoming fluid enters the first inlet In-1 and the second inlet In-2 of the CCV 100 as described earlier for modes 1A and 1B. However, in this rotational position, the RBV 12 and the RDV 40 are rotated clockwise CW relative to the second rotational position of mode 1B depicted in FIGS. 12A, 12B. In this position, the fluid flow pathway through the CCV 100 after the fluid enters the first inlet In-1 is the same as described earlier for mode 1B. However, in mode IC, the fluid flow pathway through the CCV 100 after the fluid enters the second inlet In-2 is slightly different. As shown in FIG. 13B, fluid flows only out of the third outlet opening 72C of the second housing 20B since the third fluid opening 54 overlaps only with the third outlet opening 72C. From the third outlet opening 72C, fluid then flows out of the third outlet opening 97C of the fluid manifold 94.

Modes 1A, 1B, and IC are depicted schematically in FIG. 17A. The arrows drawn in solid lines are schematic indicators of the previously described fluid connections from each of the first and second inlets In-1, In-2 to the three outlets Out-1, Out-2, Out-3. For example, in mode 1A: i) fluid enters the first inlet In-1 and is routed to the second outlet Out-2; and, ii) fluid enters the second inlet In-2 and is routed to the first outlet Out-1. In mode 1B: i) fluid enters the first inlet In-1 and is routed to the second outlet Out-2; and ii) fluid enters the second inlet In-2 and is routed to both the first outlet Out-1 and the third outlet Out-3. In mode IC: i) fluid enters the first inlet In-1 and is routed to the second outlet Out-2; and ii) fluid enters the second inlet In-2 and is routed only to the third outlet Out-3.

For the previously described modes 1A, 1B, and IC, no mixing or converging of the two fluid flow pathways occurs. Stated otherwise, the two fluid flow pathways do not deliver fluid to a same outlet. However, in an example embodiment, such mixing or converging of fluid flow pathways can occur. Turning to FIG. 11B, which coincides with mode 1A, if the third fluid opening 15C is circumferentially widened such that an edge 67A of the third fluid opening 15C is moved clockwise to an edge position 67B drawn with broken lines, overlap would occur with the first fluid gallery 31A in addition to the already present overlap with the second fluid gallery 31B. In such an instance, fluid would flow through a fluid flow pathway P1′ (FIG. 11A) that extends to the first cupped outcropping 98A of the fluid manifold 94, such that the fluid from the fluid flow pathway P1′ mixes with fluid from the fluid flow pathway P2 within the first cupped outcropping 98A and then exits the fluid manifold 94 via the first outlet opening 97A.

Turning to FIGS. 14A through 14C, a first rotational position of the second cooling mode (mode 2), identified as mode 2A, is shown. In this mode, incoming fluid enters the first inlet In-1 and the second inlet In-2 of the CCV 100. Each inlet path will be described separately.

Fluid enters the first inlet In-1 via the first manifold inlet opening 95A, the first inlet opening 70A of the second housing 20B, the ball valve inlet opening 56 of the second axial extension 41B of the RDV 40. Fluid flows upward to the RBV 12 via a through-aperture 29 of the first housing 20A and through the first fluid opening 15A to a fluid space 47 defined by the columns 46 of the RDV 40, and radially outwardly therefrom to the internal fluid chamber 14 defined by the curved wall 13 of the RBV 12. As shown in FIGS. 14A and 14B, the third fluid opening 15C of the RBV 12 overlaps with the first fluid gallery 31A of the first outlet port 22A of the first housing 20A, therefore fluid flows from the internal fluid chamber 14 to the first fluid gallery 31A. From the first fluid gallery 31A, fluid flows through: the second fluid gallery 33A, the second port opening 27A, the second fluid gallery 68A, the first cupped outcropping 98A, and the first outlet opening 97A of the fluid manifold 94. Since no portion of the third fluid opening 15C overlaps with the first fluid gallery 31B of the second outlet port 22B, fluid flow is blocked from entering the second outlet port 22B.

Fluid enters the second inlet In-2 of the CCV 100 via the second manifold inlet opening 95B and the second inlet opening 70B of the second housing 20B. From the second inlet opening 70B, fluid flows upward to the third fluid chamber 63A and then, via the second fluid opening 52 of the RDV 40, to the fourth fluid chamber 63B. From the fourth fluid chamber 63B, fluid flows back down to the third fluid chamber 63A via the third fluid opening 54 of the RDV 40. As shown in FIG. 14C, fluid then flows out of the second outlet opening 72B of the second housing 20B since the third fluid opening 54 overlaps with the second outlet opening 72B. From the second outlet opening 72B, fluid then flows out of the second cupped outcropping 98B and the second outlet opening 97B of the fluid manifold 94.

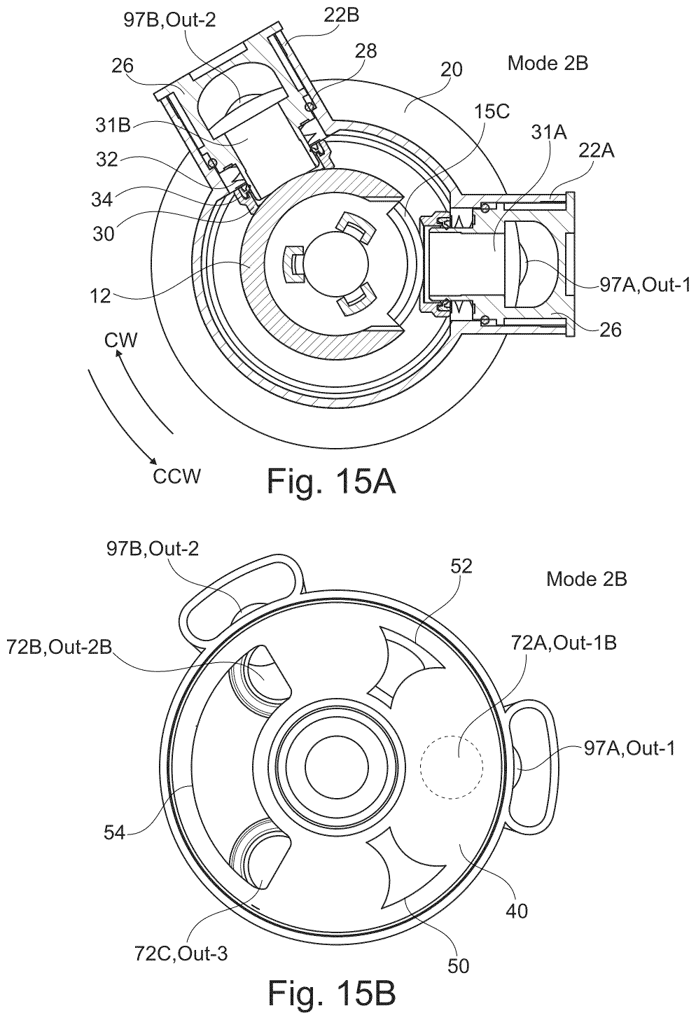

Turning to FIGS. 15A, 15B, a second rotational position that depicts mode 2B is shown. In this mode, incoming fluid enters the first inlet In-1 and the second inlet In-2 of the CCV 100 as described earlier for mode 2A. However, in this rotational position, the RBV 12 and the RDV 40 are rotated counterclockwise CCW relative to the first rotational position of mode 2A. In this position, the fluid flow pathway through the CCV 100 after the fluid enters the first inlet In-1 is the same as described earlier for mode 2A. However, in mode 2B, the fluid flow pathway through the CCV 100 after the fluid enters the second inlet In-2 is slightly different. As shown in FIG. 15B, fluid flows out of both the second outlet opening 72B and the third outlet opening 72C of the second housing 20B since the third fluid opening 54 overlaps with both the second outlet opening 72B and the third outlet opening 72C. From the second outlet opening 72B, fluid then flows out of the second cupped outcropping 98B and the second outlet opening 97B of the fluid manifold 94. From the third outlet opening 72C, fluid then flows out of the third outlet opening 97C of the fluid manifold 94. It should be noted from FIG. 15B that a slightly further clockwise CW rotation of the RBV 12 and the RDV 40 would yield a lower overlap between the third fluid opening 54 and the third outlet opening 72C, yielding a lower fluid flow rate, and a greater overlap between the third fluid opening 54 and the second outlet opening 72B, yielding a greater fluid flow rate. Furthermore, the overlap can vary for each of the second and third outlet openings 97B, 97C from zero or no overlap (no flow) to full overlap (maximum flow).

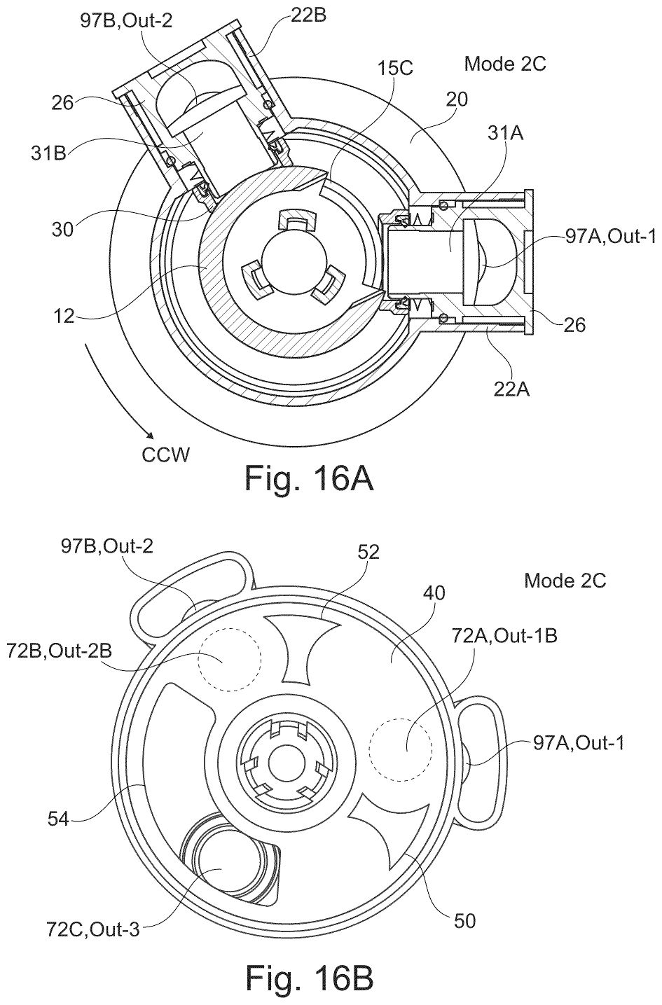

Turning to FIGS. 16A, 16B, a third rotational position that depicts mode 2C is shown. In this mode, incoming fluid enters the first inlet In-1 and the second inlet In-2 of the CCV 100 as described earlier for modes 2A and 2B. However, in this rotational position, the RBV 12 and the RDV 40 are rotated counterclockwise CCW relative to the second rotational position of mode 2B. In this position, the fluid flow pathway through the CCV 100 after the fluid enters the first inlet In-1 is the same as described earlier for mode 1B. However, in mode 2C, the fluid flow pathway through the CCV 100 after the fluid enters the second inlet In-2 is slightly different. As shown in FIG. 16B, fluid flows only out of the third outlet opening 72C of the second housing 20B since the third fluid opening 54 only overlaps with the third outlet opening 72C. From the third outlet opening 72C, fluid then flows out of the third outlet opening 97C of the fluid manifold 94.

The previously described cooling modes illustrate that the RDV 40 is capable of fluidly connecting the third fluid opening 54 to two different pairs of the three outlet openings 72A, 72B, 72C.

Modes 2A, 2B, and 2C are depicted schematically in FIG. 17B. The arrows drawn in solid lines are schematic indicators of the previously described fluid connections from each of the first and second inlets In-1, In-2 to the three outlets Out-1, Out-2, Out-3. For example, in mode 2A: i) fluid enters the first inlet In-1 and is routed to the first outlet Out-1; and ii) fluid enters the second inlet In-2 and is routed to the second outlet Out-2. In mode 2B: i) fluid enters the first inlet In-1 and is routed to the first outlet Out-1; and ii) fluid enters the second inlet In-2 and is routed to both the second outlet Out-2 and the third outlet Out-3. In mode 2C: i) fluid enters the first inlet In-1 and is routed to the first outlet Out-1; and ii) fluid enters the second inlet In-2 and is routed to the third outlet Out-3.

The previously described cooling modes and corresponding rotational positions of the RBV 12 and RDV 40 only represent a fraction of the cooling modes and rotational positions that are possible with the CCV 100. For example, it is evident from the figures that the RBV 12 could be rotated to a position in which a throttled fluid flow (due to only a partial overlap with the first and second fluid galleries 31A, 31B and the third fluid opening 15C) of the first inlet In-1 is communicated to one of the first or second outlet ports 22A, 22B of the first housing 20A. In a further aspect, the third fluid opening 15C could be circumferentially lengthened to enable simultaneous fluid delivery (and variably throttled) to both the first and second outlet ports 22A, 22B. It is also evident from the figures that the RBV 12 could be rotated to a position in which no fluid flow is delivered to either one of the first or second outlet ports 22A, 22B of the first housing because no overlap of the third fluid opening 15C with the first fluid galleries 31A, 31B is present. It is also evident from the figures that a circumferential span of the third fluid opening 54 of the RDV 40 could be adjusted (lengthened, shortened, segmented) so that in certain rotational positions of the RBV 12 and the RDV 40, no exiting fluid flow occurs from the second housing 20B. Many other suitable cooling modes and operational positions not described herein are also possible.

In addition to the variants described above, the number of inlets and outlets for each of the first housing 20A and the second housing 20B can be varied from that which is shown and described herein. Further, what are shown as inlets within the figures could be outlets and what are shown as outlets within the figures could be inlets. In such a scenario, a direction of the fluid flow within the CCV 100 could be reversed compared to that which is identified by first and second fluid flow pathways P1, P2. Additionally, the number of fluid openings and the sizes thereof can also be varied from that which is shown and described herein.

The previously described CCV 100 can be configured to receive any fluid such as a gas or liquid. Further, the liquid can be any liquid, including but not limited to, water, ethylene glycol, or a mix thereof. The liquid could also be maintained at a pressure so as to maintain a liquid form, such as liquid propane.

A wide range of suitable materials could be utilized for the previously described components of the CCV 100, including, but not limited to thermoplastic, aluminum, and steel.

The assembly of the previously described CCV 100 could be accomplished via known methods, including, but not limited to heat staking, hot-plate welding, infrared welding, laser transmission welding or laser absorption welding. Other suitable assembly methods that sealably attach or fix the previously described stacked CCV components together could also be used. Further, features could be added which would enable a snap-fit between two adjacent components.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A coolant control valve comprising:
an electric actuator;
a valve housing comprising:
a first housing having:
at least one inlet and at least one outlet; and
a first fluid chamber; and
a second housing sealingly engaged with the first housing, the second housing having:
at least one inlet and at least one outlet; and
a second fluid chamber axially adjacent to the first fluid chamber;
a rotary ball valve disposed within the first fluid chamber and actuated about a first axis by the electric actuator, the rotary ball valve having at least one fluid opening; and
a rotary disc valve disposed within the second fluid chamber and non-rotatably coupled to the rotary ball valve, the rotary disc valve having at least one fluid opening.

2. The coolant control valve of claim 1, wherein the first housing is arranged between the electric actuator and the second housing in an axial direction.

3. The coolant control valve of claim 1, wherein a wall of one of the first housing or the second housing separates the first fluid chamber from the second fluid chamber.

4. The coolant control valve of claim 2, wherein the rotary disc valve is disposed in the first fluid chamber and the second fluid chamber.

5. The coolant control valve of claim 1, wherein the at least one inlet of the first housing comprises a first inlet extending through the second housing.

6. The coolant control valve of claim 5, wherein the first housing further comprises a first outlet, and the first inlet is disposed radially inwardly of the first outlet.

7. The coolant control valve of claim 1, wherein the at least one outlet of the first housing comprises a first outlet extending through the second housing.

8. The coolant control valve of claim 7, wherein the first outlet is sealingly isolated from the second fluid chamber.

9. A coolant control valve comprising:
an electric actuator;
a rotary valve configured to be actuated about a first axis by the electric actuator, the rotary valve having:
a first rotary valve having a hollow body defining an internal fluid chamber, the internal fluid chamber configured to receive fluid in a first axial direction and exit fluid in a radial direction;
a second rotary valve non-rotatably coupled to the first rotary valve, the second rotary valve having a disc portion configured to receive fluid in the first axial direction and exit fluid in a second axial direction opposite to the first axial direction; and
the electric actuator, the first rotary valve, and the second rotary valve stacked axially along the first axis.

10. The coolant control valve of claim 9, wherein the first rotary valve is disposed within a first fluid chamber, and the second rotary valve is disposed within a second fluid chamber separate from the first fluid chamber.

11. The coolant control valve of claim 10, further comprising:
a first housing defining the first fluid chamber; and
a second housing defining the second fluid chamber; and
the disc portion includes at least one fluid opening extending through the disc portion, the at least one fluid opening configured to be in selective fluid communication with at least one outlet of the second housing.

12. The coolant control valve of claim 11, wherein:
the second housing further comprises a first inlet fluid opening configured to receive fluid into the second fluid chamber;
the disc portion further comprises:
a first fluid opening configured to receive fluid from the first inlet fluid opening; and
a second fluid opening configured to exit fluid from the second fluid chamber.

13. The coolant control valve of claim 12, wherein the second housing further comprises at least two outlets, and the second fluid opening is configured to rotate so as to selectively vary an overlap between the second fluid opening and two of the at least two outlets.

14. The coolant control valve of claim 12, wherein the second housing further comprises three outlets, and the second fluid opening is configured to fluidly connect at least two different pairs of the three outlets to the first inlet fluid opening.

15. A coolant control valve comprising:
an electric actuator;
a housing having:
at least one inlet;
at least one outlet;
a first fluid chamber; and
a second fluid chamber axially adjacent to the first fluid chamber;
a rotary hollow body valve disposed in the first fluid chamber and configured to be actuated about a first axis by the electric actuator;
a rotary disc valve non-rotatably coupled to the rotary hollow body valve, the rotary disc valve comprising a disc portion disposed in the second fluid chamber so as to divide the second fluid chamber into a third fluid chamber and a fourth fluid chamber, the fourth fluid chamber axially adjacent to the third fluid chamber, the disc portion having:
a first fluid opening configured to: i) receive fluid from one of the at least one inlet or one of the at least one outlet arranged in the third fluid chamber, and ii) deliver the fluid to the fourth fluid chamber; and
a second fluid opening configured to receive fluid from the fourth fluid chamber via the first fluid opening and deliver the fluid to: i) a first one and a second one of the at least one outlet arranged in the third fluid chamber, or ii) a first one and a second one of the at least one inlet arranged in the third fluid chamber.

16. The coolant control valve of claim 15, wherein the fourth fluid chamber is arranged between the first fluid chamber and the third fluid chamber in an axial direction.

17. The coolant control valve of claim 15, wherein the second fluid opening is configured to selectively throttle a fluid flow, via the electric actuator, to: i) the first one of the at least one outlet and to the second one of the at least one outlet, or ii) the first one of the at least one inlet and to the second one of the at least one inlet.

18. The coolant control valve of claim 15, wherein:
in a first rotational position of the rotary disc valve, the second fluid opening is configured to deliver fluid only to: i) the first one of the at least one outlet, or ii) the first one of the at least one inlet;
in a second rotational position of the rotary disc valve, the second fluid opening is configured to deliver fluid only to: i) the second one of the at least one outlet, or ii) the second one of the at least one inlet; and
in a third rotational position of the rotary disc valve, the second fluid opening is configured to deliver throttled fluid to: i) the first one and the second one of the at least one outlet, or ii) the first one and the second one of the at least one inlet.

19. The coolant control valve of claim 15, wherein one of the at least one inlet or one of the at least one outlet extends axially through the second fluid chamber and a remaining one of the one of the at least one outlet or the one of the at least one outlet extends axially through the second fluid chamber.

20. The coolant control valve of claim 15, wherein the rotary disc valve comprises a tubular portion configured as one of the at least one inlet or one of the at least one outlet.
